(19) United States
(12) Patent Application Publication
(10) Pub. No.: US 2006/0128312 A1
(43) Pub. Date: Jun. 15, 2006

(54) Wireless communication management system and supporting method and apparatus

(75) Inventors: Daniel J. Declerck, Lake Barrington, IL (US); Stanley J. Benes, Round Lake Beach, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 11/013,027

(22) Filed: Dec. 15, 2004

(51) Int. Cl. H04B 17/00

(52) U.S. Cl. 455/67.11; 455/423

(57) ABSTRACT

Management of a wireless communication system (10) has been provided with a filtering threshold (34) in addition to trigger events as a way to control handovers of mobile stations (12, 14). In a non-active set base station process, it is determined (106) whether a signal strength measurement of a base station in a non-active set of a mobile station is less than the filtering threshold (34). If not, the predefined event is executed (108). Otherwise, the signal strength measurement is ignored (112). For an active set base station process, it is determined (206) whether a signal strength measurement of a base station in the active set of the mobile station is less than the filtering threshold (34). If not, the signal strength measurement is again compared (212) to an event threshold defined by an event. The signal strength measurement of the base station is ignored (214) when the signal strength measurement is not less than the event threshold.

### TECHNICAL FIELD

This invention relates generally to wireless communication management.

### BACKGROUND

In developing cellular systems, the industry has used handover technology to reduce the total amount of power employed to provide an acceptable signal to noise ratio for an individual user. Typically, the trigger point to change cells or nodes occurs when a new signal path between a base station and a mobile station is better than the currently active radio link. This technique serves well in systems where a re-use pattern is used to improve carrier-to-interference ratio for added capacity and link quality, which includes both analog systems and early digital systems.

As systems evolve using Code Division Multiple Access (“CDMA”), the nature of the receivers of the mobile stations is changing. Systems are now built with a so-called 1-1 frequency reuse pattern. This is enabled by the use of fast power control algorithms, such as changing power levels at a rate of more than 800 Hz with the number of levels ranging in the thousands. Additionally, CDMA systems provide capability to combine symbols transmitted from a diverse set of antennas. This capability facilitates soft handover, where the mobile station can receive and combine the signals from a number of base stations and sectors. The combination signal is used to improve the quality of the signal over a non-combined, single source signal. The set of signals (e.g., emanating from base stations) being combined and decoded is generally known as the active set.

Currently, CDMA systems employ soft handover to provide a diversity gain that allows base station power control algorithms to reduce the power necessary to achieve a link quality target while minimizing noise contributions to neighboring mobile receivers. Any CDMA channel energy that is not decoded and utilized by the receiver is considered additional noise to a mobile. As a result, if a handover site or sector is added to the active set that does not assist in increasing diversity gain on the forward link (e.g., the sector is experiencing poor power control), the overall system capacity is actually reduced by adding noise to other mobile stations.

### BRIEF DESCRIPTION OF THE DRAWINGS

The above needs are at least partially met through provision of the wireless communication handover method and apparatus described in the following detailed description, particularly when studied in conjunction with the drawings, wherein:

FIG. 1 comprises a block diagram of a typical wireless communication system suitable for various embodiments of the invention;

FIG. 2 comprises a flow diagram of a non-active set process according to an embodiment of the invention;

FIG. 3 comprises a flow diagram of an active set process according to an embodiment of the invention;

FIG. 4 is a table providing exemplary handover trigger events used with the present invention according to an embodiment of the invention;

FIG. 5 comprises a flow diagram of a 1A event process of a network controller configured in accordance with an embodiment of the invention;

FIG. 6 comprises a flow diagram of a 1B event process of a network controller configured in accordance with an embodiment of the invention;

FIG. 7 comprises a flow diagram of a 1C event process of a network controller configured in accordance with an embodiment of the invention;

FIG. 8 comprises a flow diagram of a 1A event process of a mobile station configured in accordance with an embodiment of the invention;

FIG. 9 comprises a flow diagram of a 1B event process of a mobile station configured in accordance with an embodiment of the invention; and

FIG. 10 comprises a flow diagram of a 1C event process of a mobile station configured in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a filtering threshold is provided for use with multiple handover trigger events. In some embodiments of the invention, a signal strength measurement report of a non-active set base station is ignored when the signal strength measurement is less than the filtering threshold. On the other hand, a command based on the handover trigger event is executed when the signal strength measurement is not less than the filtering threshold. For readability, an active set base station is a base station that is a member of an active set of the mobile station, and a non-active set base station refers to a base station that is not a member of the active set of the mobile station.

Pursuant to other embodiments, a base station is dropped from the active set of the mobile station when the signal strength measurement is less than the filtering threshold. Otherwise, when the signal strength measurement is not less than the filtering threshold, it is further compared to an event threshold, which will result in the base station being dropped from the active set when the signal strength measurement is less than the event threshold.

Pursuant to such embodiments, an improved wireless communication system is provided. With the use of the threshold with multiple handover trigger events, the selection of handoff links is greatly improved, because the filtering threshold is able to pre-qualify the mobile stations before allowing the relative triggers to act upon these devices. This, in turn, permits the system to provide improved call quality and capacity while, at the same time, reducing the number of dropped calls in the system. For example, the relative trigger mode's ability to indicate a base station associated with a poor quality strength measurement is limited by the invention, even if the strength measurement satisfies the relative trigger conditions. At the same time, the base stations are dropped more seamlessly from the active set of each mobile station. These and other benefits will become more evident to those skilled in the art upon making a thorough review and study of the following detailed description.

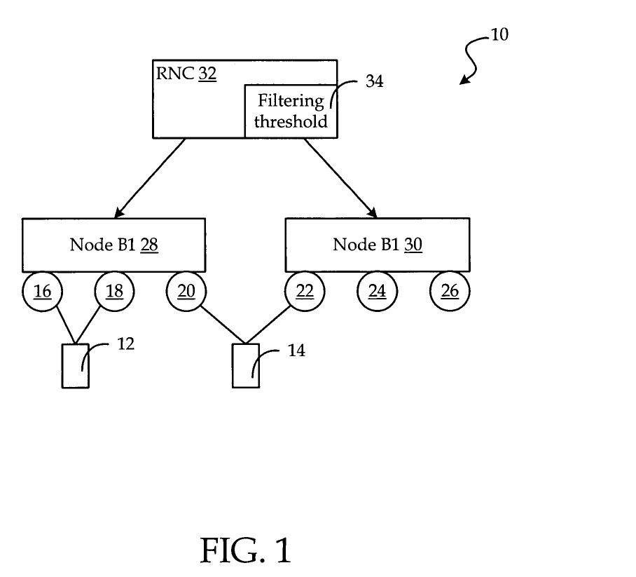

Referring now to the drawings, and in particular to FIG. 1, for purposes of providing an illustrative but non-exhaustive example to facilitate this description, a specific operational paradigm using a CDMA system will be presented. Those skilled in the art will recognize and appreciate that the specifics of this illustrative example are not specifics of the invention itself and that the teachings set forth herein are applicable in a variety of alternative settings.

Pursuant to this example, a CDMA wireless communication system 10 is shown. Since a CDMA system uses codes to identify connections, every mobile station (“MS”) 12, 14 will generally be allocated an entire spectrum. Specifically, unique spreading codes are used to spread baseband data before transmission thereof. A rate of a spreading code is referred to as a chip rate. A signal comprising the spread data is then transmitted in a channel that is below noise level. Upon receipt of the signal, a correlator is used to despread the received signal, which is passed through a narrow bandpass filter.

Handover in the CDMA system occurs when a call must be passed from one cell to another as a mobile station 12, 14 moves between cells. Since all cells in CDMA use the same frequency, it is possible to make the connection to the new cell before leaving the current cell, which is known as a “make-before-break” or “soft” handover. Soft handovers require less power, which reduces interference and increases capacity. In this example, base stations 16, 18, 20 and base stations 22, 24, 26 are respectively grouped into a first Node B 28 and a second Node B 30. Node B 28 and Node B 30 are controlled by a Radio Network Controller (“RNC”) 32 that maintains one or more filtering thresholds 34 in an associated memory of filter comparator 36, which is operably coupled to a receiver 38 that receives a signal strength measurement that is to be compared with the filtering thresholds. The filter comparator 36 is also connected to a controller 40 that ignores the signal strength measurement of the base station when it is less than the filtering threshold, and otherwise, executes a command based on a predefined event. Although only one RNC 32 is shown as an example, in a given system, there would usually be multiple RNCs connected to each other for controlling the behavior of Node B's, which in turn may consist of multiple groupings of base stations.

As an example of a “soft” handover, the mobile station 14 is connected to at least two base stations (“BSs”) 20, 22 with each respectively belonging to a different Node B 28, 30. Softer handover is a special case of soft handover where the radio links that are added and removed belong to the same Node B. As an example of softer handover, the mobile station 12 is connected to two separate base stations 16, 18 that respectively belong to the same Node B 28.

CDMA mobile stations generally use rake receivers, which are essentially a set of several receivers. One of the receivers or fingers of the mobile station constantly searches for different multipaths and feeds the information to other fingers. Each finger then demodulates the signal corresponding to a strong multipath. The results are then combined together to make the signal stronger. There is a diminishing return on adding increasing numbers of soft handover legs, based on the number of fingers in the mobile station's receiver. Moreover, the amount of diminishing return can be highly dependent upon the finger management algorithms, processing gain obtained by the channel configuration (e.g., Radio Access Bearer), and the amount of multipath the mobile station is experiencing and its associated receiver performance gain. The delay in infrastructure to add a handover leg or delay in making a handover leg usable (e.g., the synchronization delay inherent in Universal Mobile Telecommunications System (UMTS)) and slow performing signaling control stacks can also be a factor in diminishing return.

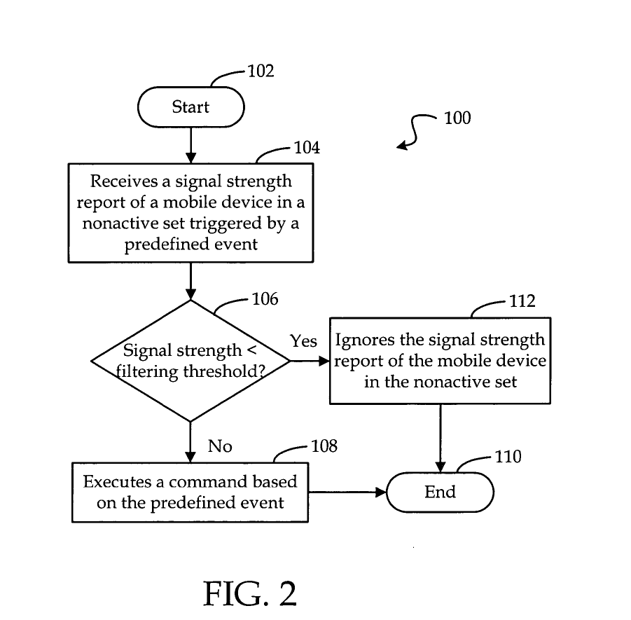

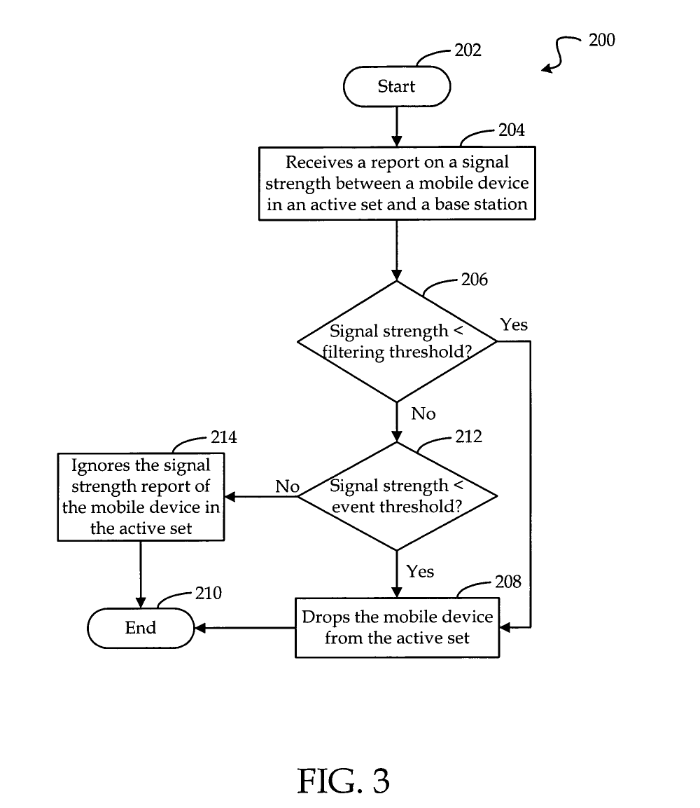

Referring now to FIGS. 2 and 3, logic flow diagrams are provided that depict a management process of signal strength measurement reports associated with non-active set base stations and active set base stations according to an embodiment of the present invention. In one such embodiment of the present invention, the processes shown in FIGS. 2 and 3 may be implemented by the RNC 32, but other implementations are contemplated. For example, in other embodiments of the present invention, the processes may be distributed between the RNC and the Node B. As a result, these various embodiments that may require slight modifications of the processes shown are contemplated, and they are within the scope of various teachings shown.

FIG. 2 is a logic flow diagram of a management process of signal strength measurement reports associated with non-active set base stations according to an embodiment of the invention and is indicated generally at 100. The process first starts 102 by the RNC 32 receiving 104 a signal strength measurement report from a mobile station 12, 14 with respect to a non-active set base station, in which the sending of the report is triggered by a predefined event. Specifically, in response to receiving a pilot signal from the non-active set base station, the mobile station determines whether a predefined event has been triggered. If so, the mobile station sends the signal strength measurement report to the RNC. The RNC starts 102 the process in response to a signal strength measurement report being received from the mobile station.

In various embodiments of the invention, the mobile station tracks the signal strength measurement of nearby candidate non-active set base stations. Specifically, as the mobile station approaches a non-active set base station, the signal strength measurement of the candidate non-active set base station would reach an event threshold that triggers the signal strength measurement report to be sent to the RNC. The signal strength measurement report, in one embodiment, is similar to a request to add the non-active set base station to the active set of the mobile station.

In response to the receiving of the report, the RNC 32 compares 106 the signal strength measurement associated with the report to a filtering threshold 34 maintained by the RNC. Specifically, according to one embodiment, the RNC 32 determines 106 whether the signal strength measurement is less than the filtering threshold. If not, a command associated with the predefined event that triggered the report is executed 108 and the process ends 110 until another report is received. In the case where the signal strength measurement is less than the filtering threshold 34, however, the RNC is adapted to simply ignore 112 the signal strength measurement report. Consequently, the RNC will take no action, such as an adding of the candidate non-active set base station to the active set or a swapping of the non-active set base station with an active set base station, relating to the report sent from the mobile station even through a report was triggered by an event.

Turning now to FIG. 3, a logic flow chart diagram of a management process of signal strength measurement reports associated with active set base stations according to an embodiment of the invention is shown and indicated generally at 200. In this process, a mobile station 12, 14 monitors the signal strength measurement changes of the active set base stations. As the mobile station moves away from an active set base station, the signal strength measurement of the active set base station would eventually decrease below another event threshold that triggers a signal strength measurement report to be sent to the RNC. In this scenario, the signal strength measurement report, in these various embodiments, is similar to a request to drop the active set base station from the active set of the mobile station.

As such, the process starts 202 by the RNC 32 receiving 204 a signal strength measurement report associated with a base station in the active set of the mobile station. The RNC 32 compares 206 the signal strength measurement associated with the report to a filtering threshold 34 maintained by the RNC. Specifically, in this embodiment shown, the RNC 32 determines 206 whether the signal strength measurement is less than the filtering threshold. If the signal strength measurement associated with the report is less than the filtering threshold, the RNC is adapted to drop 208 the active set base station from the active set of the mobile station. The process ends 210 at this point since an action has been taken in response to the signal strength measurement report. It should be noted, however, that the filtering threshold of the active set process shown in FIG. 3 may be the same or different from the filtering threshold of the non-active set process shown in FIG. 2. A preferred filtering threshold value highly depends upon the configuration of the communication system, specification of the mobile stations, and types of data being transmitted through the system. Thus, it is nearly impossible to determine a single preferred filtering threshold value for all the systems. In fact, there may be multiple filtering thresholds optimized for each event. Nevertheless, the value or values of the filtering threshold needed for any given implementation is readily ascertainable by one skilled in the art. As a result, other values for and the total number of the filtering threshold are contemplated and within the scope of the present invention.

If the signal strength measurement turns out to be not less than the filtering threshold, the signal strength measurement is then compared 212 to an event threshold. Preferably, the event threshold relates to the event that precipitated a dropping of the active set base station from the active set of the mobile station. In one embodiment, is the RNC 32 determines 212 whether the signal strength measurement is less than the event threshold, and if so, the active set base station is dropped 208 from the active set of the mobile station. Otherwise, the RNC ignores 214 the signal strength measurement report from the mobile station, which ends the process 210 until a next signal strength measurement report from a mobile station with respect to an active set base station is obtained. The processes described along with the filtering threshold enables the RNC to manage the wireless communication system more seamlessly. In embodiments of the invention, the filtering threshold provides an improved optimized relative threshold in addition to the absolute threshold within the system. As a result, relative triggers that result in detrimental additions of non-active set base stations to the active set of the mobile station are prevented, which reduces handover messaging traffic and dropped calls in non-optimal cases. Moreover, Node B power output and power amplifier overload conditions (×100) also may be greatly reduced.

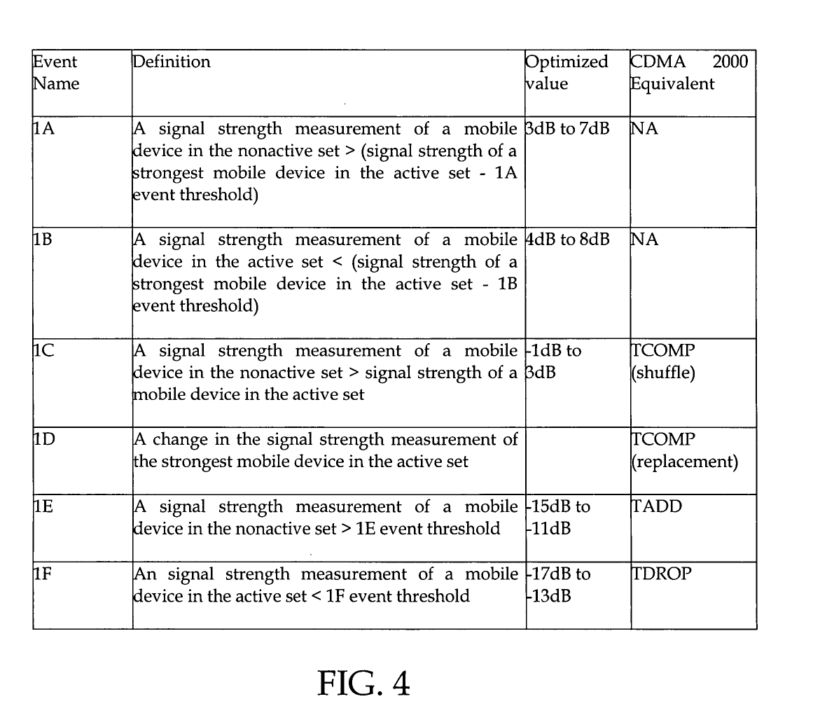

Turning now to FIG. 4, existing handover trigger events that may be used by communication system 10 are shown as an example. Illustrated as a specific implementation, well known handover trigger events 1A, 1B, 1C, 1D, 1E, and 1F are used with the above-described filtering threshold. In particular, the 1A event is triggered in the system when the signal strength measurement associated with a non-active set base station becomes greater than a value produced by subtracting a 1A event threshold from a strongest signal strength measurement associated with the active set base stations or from the aggregate signal quality of the active set. The 1A event can also be triggered when the signal strength measurement is greater than a predetermined interval of the signal strengths in the active set minus the 1A event. The 1B event, on the other hand, is triggered when the signal strength measurement of an active set base station becomes less than a value produced by subtracting a 1B event threshold from a strongest signal strength measurement associated with the active set base stations or from the aggregate signal quality of the active set. The 1C event is triggered when a signal strength measurement of a non-active set base station becomes greater than a signal strength measurement of any base station in the active set. Similarly, the 1C event can also be triggered when the signal strength measurement is greater than a predetermined interval of the signal strength measurements in the active set minus the 1C event.

A change in the strongest signal strength in the active set triggers the 1D event. Finally, the 1E event is triggered when a signal strength measurement associated with a non-active set base station becomes greater than a 1E threshold, and the 1F event is triggered when a signal strength measurement associated with an active set base station becomes less than a 1F threshold. The definitions of these events are well known in the art. Moreover, although in this illustrative example the signal strength measurements are used as the triggered parameter, other parameters, for example, signal quality metrics such as a signal-to-noise ratio (SNR), a carrier-to-interference ratio (C/I), a frame error rate (FER), or a bit error rate (BER), may also be used depending on the implemented communication system. As a result, the present invention can be implemented with various parameters and events in any given system. These various implementations and embodiments are readily appreciated by one skilled in the art, and they are within the scope of the present invention.

Generally, a base station should not be under-provisioned (e.g., under utilized), but at the same time, additional usage raises the channel noise floor (N₀). For example, in CDMA systems, a missed handover candidate that is not added to the active set at a future time may not only result in a dropped call due to excessive interference, it may also induce power control algorithms to apply more power to this particular mobile station, which raises the channel noise floor (N₀) for all the other users. As a result, to address some of these problems of the CDMA system using the trigger events shown in FIG. 4, some preferred filtering threshold and event threshold values may be used that is optimized for the particular system. These threshold values, however, can be set according to the configuration and limitations of any types of systems. Thus, it should be understood that the various teachings described are not limited to the system, events, and the threshold described herein. These various implementations are readily appreciated by a skilled artisan, and they are within the scope of the present invention.

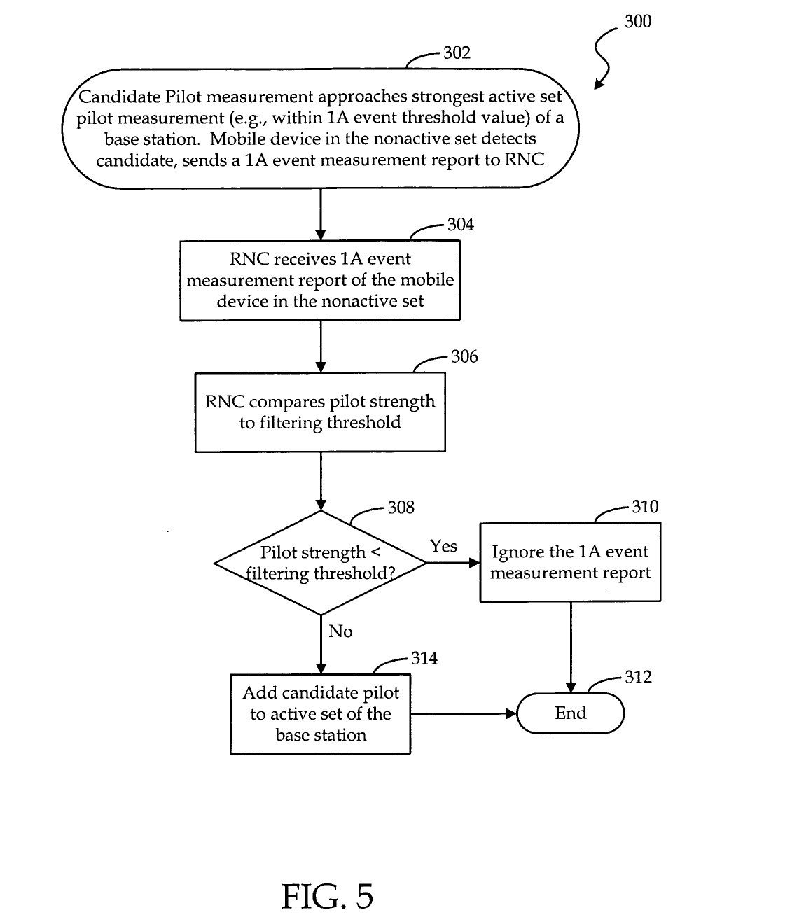

Turning to FIG. 5, a logic flow diagram of a 1A event process is shown and indicated generally at 300. The process is initiated by a candidate pilot measurement, that is, a measurement of a pilot associated with a candidate non-active set base station, approaching a strongest active set pilot measurement or aggregate quality measurement of the active set, specifically within a 1A event threshold value. In particular, a mobile station 12, 14 monitors the active set base stations and candidate non-active set base stations. If a candidate pilot measurement approaches a strongest pilot measurement in the mobile station's active set or an aggregate quality measurement of all pilots in the active set, the mobile station takes action by issuing an event. In other words, the mobile station detects that the candidate pilot measurement complies with a 1A event and sends a 1A event measurement report comprising the candidate pilot measurement and triggered by thresholds set by the 1A event to the RNC 32. The RNC 32 then initiates 302 the 1A event process 300. As noted above, the 1A event measurement report is triggered by the candidate pilot measurement being greater than a value produced by the strongest active set pilot measurement associated with a base station in the active set (or aggregate quality measurement of the active set) minus the 1A event threshold.

The RNC 32 receives 304 the 1A event measurement report, and compares 306 the candidate pilot measurement to a filtering threshold 34 maintained by the RNC. In one embodiment, if the candidate pilot measurement is less than the filtering threshold 308, meaning the candidate pilot measurement did not pass the filtering threshold, the 1A event measurement report is ignored 310 and no action will be taken by the RNC. The process ends 312 until another report is received. On the other hand, if the candidate pilot measurement passes the filtering threshold 308 (e.g., it is not less than the filtering threshold), the pilot of the candidate non-active set base station is added 14 to the active set of the mobile station, which effectually adds the candidate base station to the active set of the mobile station. The process then ends 312 until the next report is received.

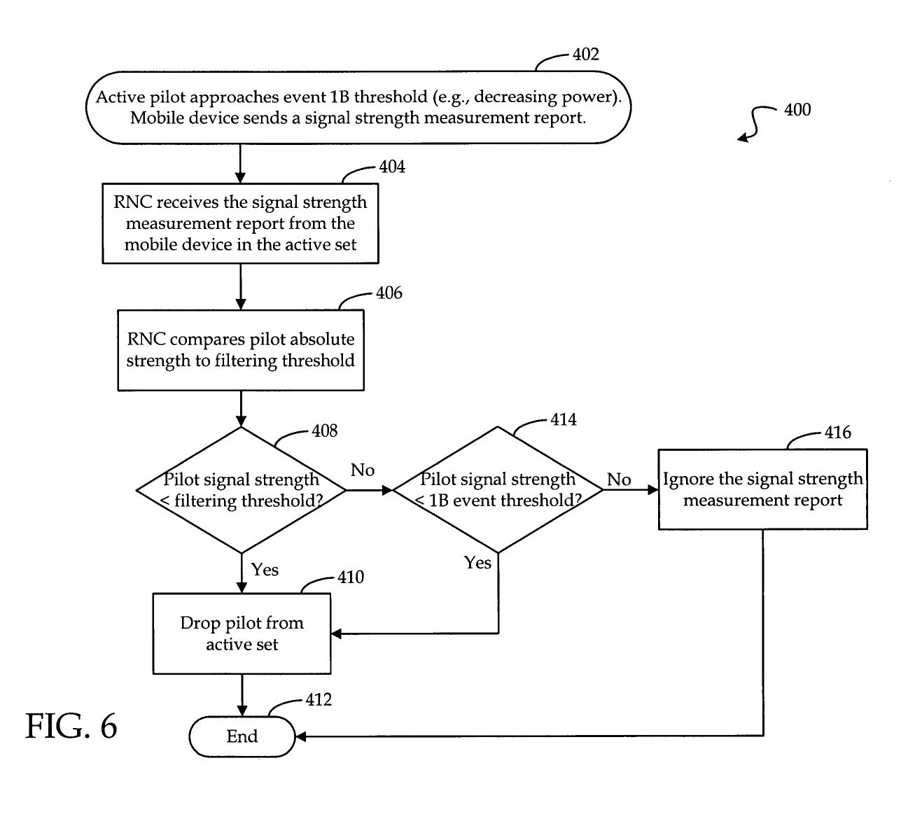

Turning now to FIG. 6, a logic flow diagram of a 1B process is shown and indicated generally at 400. This process is initiated 402 by the RNC 32 receiving 404 a signal strength measurement report from a mobile station 12, 14 with respect to an active set base station. In one embodiment, the report is generated through a monitoring of the active set pilots by the each mobile station 112, 114. Each mobile station then periodically sends signal strength measurement reports to the RNC 32. In another embodiment, the sending of the signal strength measurement report may be triggered by a 1B event. In particular, the mobile station may send a signal strength measurement report when a pilot signal strength measurement associated with an active set base station has reached a point that it is less than the strongest signal strength measurement of a base station in the active set minus a 1B event threshold. Since the signal strength measurement of the active set pilots are monitored dynamically in most current systems, the flow diagram has been configured to work with the currently available systems as an example. However, other embodiments are contemplated and are readily appreciated by a skilled artisan.

In the scenario depicted in FIG. 6, the mobile station determines that the pilot signal strength measurement associated with the active set base station is approaching the filter threshold as the mobile station is moving away from the active set base station (e.g., decreasing signal strength). A signal strength measurement report comprising the pilot signal strength measurement is sent to the RNC 32 for processing. In response to receiving 404 the signal strength measurement report, the RNC compares 406 the pilot measurement to a filtering threshold 34 maintained by the RNC and determines 408 whether the pilot measurement is less than the filtering threshold. When the pilot measurement is less than the filtering threshold (e.g., the pilot measurement did not pass the filtering threshold), the RNC drops 410 the pilot from the active set before the pilot measurement is compared to the 1B event threshold. The process then ends 412. Note that the 1B event process may thus bypass the checks of the 1B event threshold. As noted, other embodiments are contemplated, such as the report being triggered by the 1B event threshold, and the process and the filtering threshold can be changed to accommodate other implementations. However, these changes are readily appreciated by one skilled in the art, and they are within the scope of the present invention.

If, on the other hand, when the pilot measurement is not less than the filtering threshold, that is, when the pilot measurement passes the check with the filtering threshold, the RNC compares 414 the pilot measurement to a 1B event threshold. In particular, the RNC determines 414 whether the pilot measurement is less than the 1B event threshold. If the pilot measurement is less than the 1B event threshold, the RNC drops 410 the pilot from the active set. Thus the logic flow depicted by FIG. 6 provides two separate opportunities for an active set pilot to be dropped from the active set of a mobile station. As a result, the overload conditions of Node B are greatly reduced, since the active pilot is imposed with two different check points to stay active to a mobile station. However, if the pilot measurement is not less than the 1B event threshold, which may indicate that the active set base station is not sufficiently far away from the mobile station to be inefficient, the RNC ignores 416 the signal strength measurement report and the process ends 412 until receipt of another signal strength measurement report. Of course, in different implementations, any of the processes can be running concurrently to one another. For simplicity, the processes shown to end with each report.

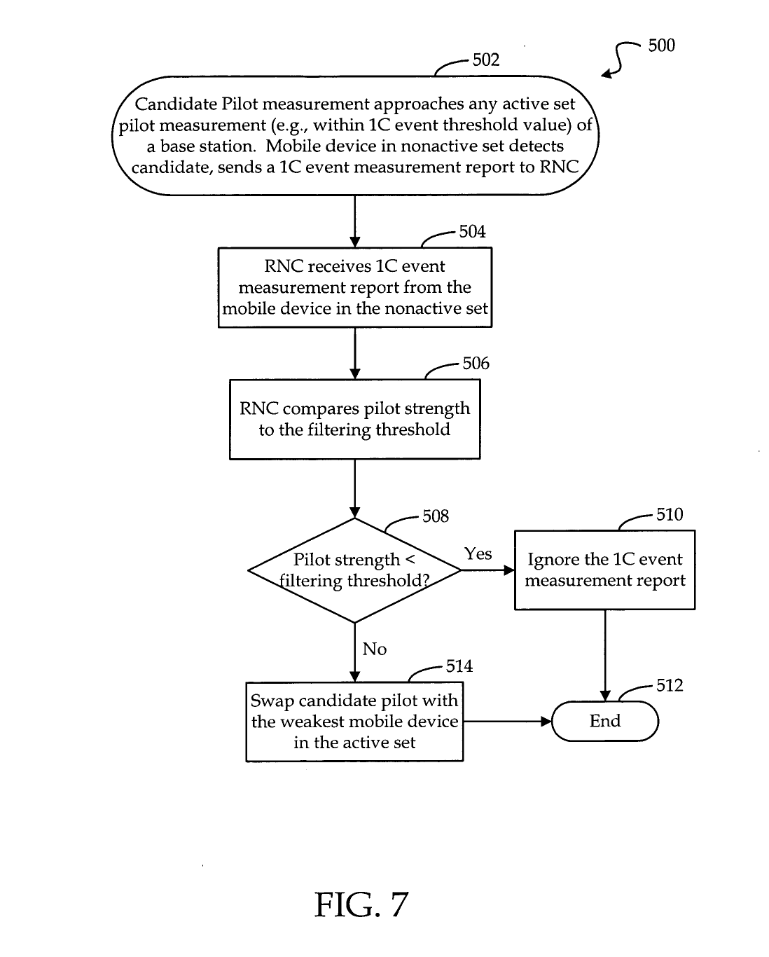

Turning to FIG. 7, a logic flow diagram of a 1C event process is shown and indicated generally at 500. Similar to the 1A event, this process is initiated 502 by a mobile station 12, 14 determining that a pilot signal strength measurement associated with a non-active set base station is approaching any active set pilot signal strength measurement (e.g., within the 1C event threshold value) of the mobile station. Specifically, the pilot measurement associated with a non-active set base station is approaching any active set pilot measurement of the mobile station (e.g., increasing signal strength). Upon the pilot measurement associated with the non-active set base station being greater than the signal strength measurement associated with any base station in the active set of the mobile station, the 1C event is triggered and a 1C event measurement report is sent to the RNC 32. The RNC receives 504 the 1C event measurement report, which comprises the non-active set base station pilot measurement. The RNC then compares 506 the pilot measurement associated with the non-active set base station with a filtering threshold 34 maintained by the RNC and determines 508 whether the pilot measurement is less the filtering threshold. If the pilot measurement is less the filtering threshold, which means that the pilot measurement of the non-active set base station did not pass the filtering threshold although it passed the 1C event threshold, the 1C event measurement report is ignored 510 by the RNC. The process ends 512 at this point. On the other hand, if the pilot strength is not less than the filtering threshold, the pilot strength passes the filtering threshold and the RNC swaps 514 the non-active set base station with a weakest pilot in the active set of the mobile station. In other words, the pilot associated with the non-active set base station is added to the active set of the mobile station and the weakest pilot is deleted from the active set, which brings the process to an end 512.

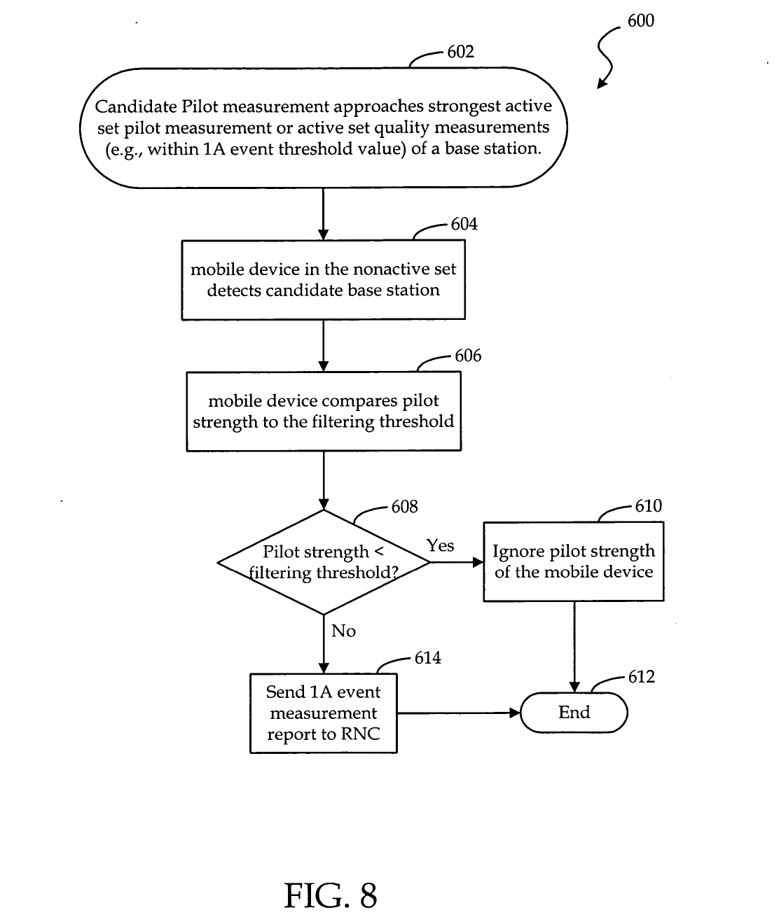

Turning now to FIG. 8, a logic flow diagram of 1A event process configured for a mobile station is shown and indicated generally at 600. In the embodiments shown in FIGS. 8-10, a mobile station 12, 14 is managing the event processes and the filtering threshold and the event thresholds are maintained in a memory of the mobile station. As a result, the mobile station can make trigger event decisions without the need of the RNC.

The process depicted in FIG. 8 is initiated 602 with the mobile station detecting 604 a candidate pilot of a non-active set base station and measuring a signal strength of the candidate pilot. The mobile station determines 606 whether the candidate pilot measurement associated with the non-active set base station is approaching a strongest active set pilot measurement (or active set quality measurements) that is within 1A event threshold value stored by the mobile station. Specifically, the mobile station compares 608 the candidate pilot measurement associated with the non-active set base station to a filtering threshold maintained by the mobile station and determines 610 whether the candidate pilot measurement is less than the filtering threshold. If so, the mobile station ignores 612 the candidate pilot measurement of the non-active set base station, even through it passes the 1A event threshold that would otherwise trigger such a report. The process ends 614 at this point. If, on the other hand, the candidate pilot measurement is in fact not less than the filtering threshold, the mobile station sends 616 a 1A event measurement report comprising the candidate pilot measurement to the RNC 32.

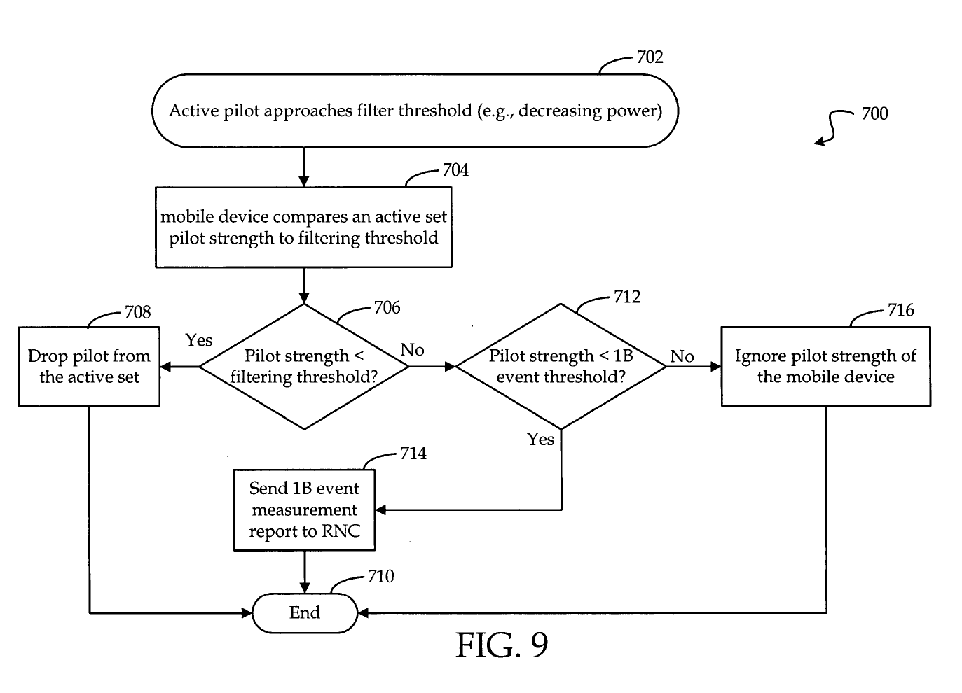

FIG. 9 shows a logic flow diagram of a 1B event process configured for a mobile station 12, 14, which is indicated generally at 700. The process is triggered 702 by the mobile station determining 704 that a pilot signal strength measurement associated with an active set base station is approaching the filtering threshold (e.g., the active pilot strength is decreasing in power). In response, the mobile station compares 706 the active set pilot measurement to a filtering threshold maintained by the mobile station and determines 708 whether the active set pilot measurement is less than the filtering threshold. If the active set pilot measurement is less than the filtering threshold, the mobile station drops 710 the pilot associated with the active set base station from the active set. The mobile station may further inform 712 the RNC 32 of the dropped pilot, which completes 714 the process. On the other hand, if the active set pilot measurement is not less than the filtering threshold, the mobile station compares 716 the active set pilot measurement to a 1B event threshold maintained by the mobile station and determines whether the active set pilot measurement is less than the event threshold. If the active set pilot measurement is less than the event threshold, the mobile station sends 718 a 1B event measurement report comprising the active set pilot measurement to the RNC 32, which brings the process to an end 714. Otherwise, the mobile station ignores 720 the active set pilot measurement, which ends 714 the process.

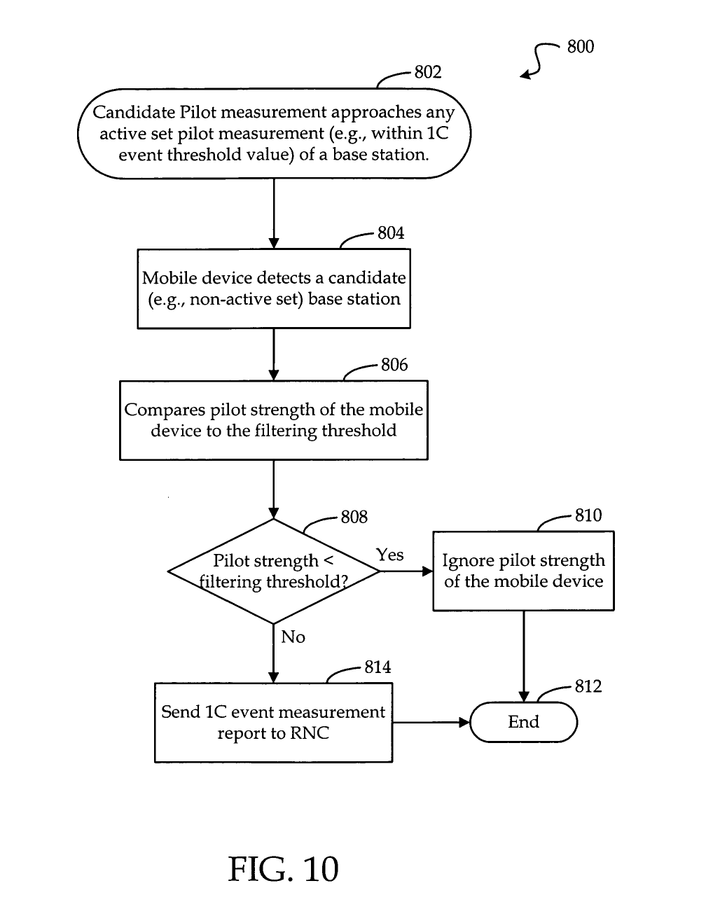

FIG. 10 shows a logic flow diagram of a 1C event process configured for a mobile station 12, 14, which is indicated generally at 800. The process starts 802 by the mobile station detecting 804 a candidate pilot of a base station in the non-active set station and measuring a signal strength of the candidate pilot. The mobile station next determines 806 that the candidate pilot measurement is approaching any pilot signal strength measurement (e.g., within the 1C event threshold value) associated with base stations in the active set. Responsive to this determination, the mobile station then compares 808 the candidate pilot measurement of the non-active set base station to a filtering threshold maintained by the mobile station and determines 810 whether the candidate pilot measurement is less than the filtering threshold. The candidate pilot measurement is ignored 812 by the mobile station if it is less than the filtering threshold, and the process ends 814. If, however, the pilot strength is not less than the filtering threshold, the mobile station sends 816 a 1C event measurement report comprising the candidate pilot measurement to the RNC 32, which completes 814 the process at this point.

Through the use of various teachings shown, an improved wireless communication system is provided. The threshold combined with the multiple handover trigger events provides for more seamless handovers in the system. The selection of handoff links is improved, because the filtering threshold is able to pre-qualify the devices before allowing the relative triggers to act upon these devices. Consequently, call quality and capacity are improved, but the number of dropped calls is reduced at this time. The relative trigger mode's ability to add poor quality devices is greatly limited, even if the devices satisfy the relative trigger conditions. The devices are dropped more seamlessly and rationally from each base station. As a result, an improved wireless communication system has been provided.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for managing wireless communications comprising:
determining whether a signal strength measurement of a base station in an non-active set of a mobile station is less than a filtering threshold;
ignoring the signal strength measurement of the base station when the signal strength is less than the filtering threshold;
executing a command based on a predefined event when the signal strength measurement is not less than the filtering threshold.

2. The method according to claim 1 further comprising:
receiving a signal strength measurement report of the base station in the non-active set from the mobile station, wherein the report is triggered by the predefined event.

3. The method according to claim 1, wherein the filtering threshold is the same as any one or more thresholds from a group of handover trigger events: 1E event triggered when the signal strength measurement of the base station in the non-active set of the mobile station becomes greater than a 1E event threshold; and 1F event triggered when the signal strength measurement of a base station in an active set of the mobile station becomes less than a 1F event threshold.

4. The method according to claim 1, wherein the predefined event is any one or more selected from a group of handover trigger events: 1A event triggered when the signal strength measurement of the base station in the non-active set of the mobile station is greater than a value produced by subtracting a 1A event threshold from a strongest signal strength measurement of a base station in an active set of the mobile station, from an aggregate signal quality of the active set, or from a predetermined interval of the signal strength measurements in the active set; and 1C event triggered when the signal strength measurement of the base station in the non-active set of the mobile station is greater than a value produced by subtracting a 1C event threshold from a signal strength measurement of a base station in the active set of the mobile station, from an aggregate signal quality of the active set, or from a predetermined interval of the signal strength in the active set.

5. The method according to claim 1, wherein executing a command further comprises adding the base station to an active set of the mobile station responsive to a 1A event triggered when the signal strength measurement of the base station in the non-active set of the mobile station is greater than a value produced by subtracting a 1A event threshold from a strongest signal strength measurement of a base station in an active set of the mobile station, from an aggregate signal quality of the active set, or from a predetermined interval of the signal strength measurements in the active set.

6. The method according to claim 1, wherein executing a command further comprises swapping the base station with a base station in an active set of the mobile station that comprises a weakest signal strength measurement responsive to a 1C event triggered when the signal strength measurement of the base station in the non-active set of the mobile station is greater than a value produced by subtracting a 1C event threshold from a signal strength measurement of a base station in the active set of the mobile station, from an aggregate signal quality of the active set, or from a predetermined interval of the signal strength measurements in the active set.

7. The method according to claim 1, wherein executing a command further comprises sending a signal strength measurement report of the base station based on the predefined event.

8. The method according to claim 1, wherein executing a command further comprises sending a 1A event measurement report on the signal strength measurement of the base station in the non-active set of the mobile station, wherein the 1A event is triggered when the signal strength measurement of the base station in the non-active set of the mobile station is greater than a value produced by subtracting a 1A event threshold from a strongest signal strength measurement of a base station in an active set of the mobile station, from an aggregate signal quality of the active set, or from a predetermined interval of the signal strength measurements in the active set.

9. The method according to claim 1, wherein executing a command further comprises sending a 1C event measurement report on the signal strength measurement of the base station in the non-active set of the mobile station, wherein the 1C event is triggered when the signal strength measurement of the base station in the non-active set of the mobile station is greater than a value produced by subtracting a 1C event threshold from a signal strength measurement of a base station in the active set of the mobile station, from an aggregate signal quality of the active set, or from a predetermined interval of the signal strength measurements in the active set.

10. The method according to claim 1, wherein the signal strength measurement comprises a pilot measurement of the base station in the non-active set of the mobile station.

11. A method for managing wireless communications comprising:
determining whether a signal strength measurement of a base station in an active set of a mobile station is less than a filtering threshold;
determining whether the signal strength measurement is less than an event threshold of a predefined event when the signal strength measurement is not less than the filtering threshold;
ignoring the signal strength measurement of the mobile station when the signal strength measurement is not less than the event threshold.

12. The method according to claim 11 further comprising dropping the base station from the active set of the mobile station when the signal strength measurement is less than the event threshold.

13. The method according to claim 11 further comprising sending a signal strength measurement report of the base station based on the predefined event when the signal strength measurement is less than the event threshold.

14. The method according to claim 11 further comprising dropping the base station from the active set of the mobile station when the signal strength measurement is less than the filtering threshold.

15. The method of claim 11 further comprising:
receiving a signal strength measurement report of the base station in the active set of the mobile station, wherein the report is triggered by the predefined event.

16. The method according to claim 11, wherein the signal strength measurement comprises a pilot measurement of the base station in the active set of the mobile station.

17. The method according to claim 11, wherein the predefined event is a 1B event triggered when the signal strength measurement of the base station in the active set of the mobile station is less than a value produced by subtracting a 1B event threshold from a strongest signal strength measurement of a base station in the active set of the mobile station.

18. An apparatus for managing wireless communications comprising:
a receiver having a signal strength measurement of a base station to a mobile station;
a filter comparator operably coupled to the receiver and having a filtering threshold for comparison with the signal strength measurement of the base station;
a controller operably coupled to the filter comparator that ignores the signal strength measurement of the base station when the signal strength measurement is less than the filtering threshold and executes a command based on a predefined event when the signal strength measurement is not less than the filtering threshold.
